(19) United States
(12) Patent Application Publication
(10) Pub. No.: US 2011/0138803 A1
(43) Pub. Date: Jun. 16, 2011

(54) System of Transferring and Storing Energy and Method of Use Thereof

(76) Inventor: Ed Gilbert, JR., Dallas, GA (US)

(21) Appl. No.: 13/020,065

(22) Filed: Feb. 3, 2011

Related U.S. Application Data
(63) Continuation-in-part of application No. 12/170,493, filed on Jul. 10, 2008.
Application No. 12/170,493 is a continuation-in-part of application No. 12/061,471, filed on Apr. 2, 2008.

(51) Int. Cl. F15B 7/00

(52) U.S. Cl. 60/581

(57) ABSTRACT

A system of transferring energy and a method of use thereof, wherein the system and method utilize an energy source, a motor and a plurality of hydraulic networks of varying lengths to transfer energy to an energy output device, and wherein the energy transferred to the energy output device is selectively transferred to an external load, and wherein electromechanical interference is obviated. The system further provides for differing sizes of input hydraulic and output hydraulic networks to facilitate conformance to size constraints.

### CROSS-REFERENCE TO RELATED APPLICATIONS

To the fullest extent permitted by law, the present non-provisional patent application claims priority to, and the full benefit of the following applications: 1) non-provisional patent application Ser. No. 12/061,471, entitled “SYSTEM AND METHOD OF INCREASING THE OUTPUT ENERGY OF A MOTOR BY TRANSFERRING THE OUTPUT ENERGY THROUGH A PLURALITY OF HYDRAULIC NETWORKS”, filed Apr. 2, 2008, the entire contents of which are hereby incorporated by reference and 2) non-provisional patent application Ser. No. 12/170,493, entitled “SYSTEM AND METHOD OF INCREASING THE OUTPUT ENERGY OF AN ELECTRICAL MOTOR BY TRANSFERRING THE OUTPUT ENERGY THROUGH A PLURALITY OF HYDRAULIC NETWORKS TO CREATE A CONTINUOUS ELECTRICAL CYCLE”, filed Jul. 10, 2008, the entire contents of which are hereby incorporated by reference.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to a system of transferring energy, and more specifically transferring energy from an energy source to an energy output device via a primary hydraulic network and a secondary hydraulic network of varying length.

2. Description of Related Art

Hydraulic machinery has been utilized for years to do work in situations where the normal means of power have fallen short. Generally, hydraulic machinery includes a sending unit and a receiving unit connected via pipe lines.

Further, many devices have utilized hydraulic machinery in combination with electric motors to supply power to vehicles. Generally, an electric motor is directly or indirectly mounted to a rotary mechanism contained within the hydraulic machinery. For example, one device teaches a regenerative vehicle drive system that is either pneumatically or hydraulically controlled and has electricity as its power source. However, while such a device increases the performance ranges of hydraulic systems, the device does not transfer energy utilizing a plurality of hydraulic networks of varying sizes.

Another device teaches utilizing rotary power of one or more small electric motors to obtain a choice of higher or lower magnitudes of power and/or speed. The device comprises one or more electric motors in parallel for driving a hydraulic compressor. While such a device provides varying magnitudes of power, it does not utilize multiple hydraulic networks of varying lengths to transfer energy into an energy storage device.

Therefore, it is readily apparent that there is a need for a system of transferring and storing energy, wherein the system transfers energy utilizing hydraulic networks of varying lengths, and wherein the configuration of the receiving unit is different from the configuration of the transmitting unit.

### BRIEF SUMMARY OF THE INVENTION

Briefly described, in a preferred embodiment, the present invention overcomes the above-mentioned disadvantages and meets the recognized need for such an apparatus by providing a system of transferring energy and a method of use thereof, wherein the system and method utilize an energy source, a motor and a plurality of hydraulic networks of varying lengths to transfer energy to an energy output device, and wherein the energy transferred to the energy output device is selectively transferred to an external load, and wherein electromechanical interference is obviated. The system further provides for differing sizes of input hydraulic and output hydraulic networks to facilitate conformance to size constraints.

According to its major aspects and broadly stated, the present invention in its preferred form is a system of transferring energy comprising an input hydraulic network and an output hydraulic network, wherein the input hydraulic network comprises an input housing, an input network length, a first input cylinder and a second input cylinder, and wherein the first and second input cylinders of the input hydraulic network comprise an input cylinder diameter. The first and second input cylinders are in communication with first and second input vents, respectively, wherein the first and second input cylinders are in fluid communication with the first and second hydraulic lines, respectively.

The first and second input cylinders further comprise a first input piston and a second input piston, an input crankshaft, and a first input rod and a second input rod, wherein the first and second input rods connect the first and second input pistons, respectively, to the input crankshaft, and wherein rotation of the input crankshaft alternately thrusts the first and second input pistons along and within the first and second input cylinders, respectively.

The output hydraulic network comprises an output housing, an output network length, wherein the output hydraulic network comprises a first output cylinder and a second output cylinder, a first output piston and a second output piston, an output crankshaft and a first output rod and a second output rod, and wherein the first and second output rods connect the first and second output pistons, respectively, to the output crankshaft, and wherein rotation of the output crankshaft alternately thrusts the first and second output pistons along and within the first and second output cylinders via the first and second output rods.

The first and the second output cylinders of the output hydraulic network comprise an output cylinder diameter, wherein the first and second output cylinders are in communication with a first output vent and a second output vent, respectively.

The output network length is less than the input network length, and the input hydraulic network is in fluid communication with the output hydraulic network via a first hydraulic line and a second hydraulic line.

The system of transferring energy further comprises an energy source and an energy input mechanism, wherein the energy source is in electrical communication with the energy input mechanism via a first switch, and wherein the energy input mechanism is in mechanical communication with the energy input hydraulic network. The system of transferring energy further comprises an energy output mechanism and an external load, wherein the energy output hydraulic network is in mechanical communication with the energy output mechanism, and wherein the energy output mechanism is in electrical communication with the external load, and wherein the input cylinder diameter is less than the energy output cylinder diameter.

The preferred embodiment further comprises a method of transferring energy comprising obtaining a system for transferring energy, closing the first switch to transfer energy from the energy source to the energy input mechanism, transferring the energy from the energy input mechanism to the input hydraulic network, displacing fluid between the input hydraulic network and the output hydraulic network via first and second hydraulic lines, transferring the fluid from the first and second hydraulic lines to the output hydraulic network, transferring the energy from the output hydraulic network to the energy output mechanism, selectively recovering unused energy from momentum of the output energy mechanism, and selectively utilizing the output energy mechanism to energize the external load.

The step of displacing fluid between the input hydraulic network and the output hydraulic network via the first and second hydraulic line further comprises rotating the input crankshaft, thereby pushing the first input cylinder upward and displacing fluid in the first input cylinder into the first hydraulic line, displacing fluid in the first hydraulic line into the first output cylinder, causing the first output piston to move downward as the fluid is displaced from the first hydraulic line into the first output cylinder, wherein the downward movement of the first output piston rotates the output crankshaft, pushing the second output piston upward via rotation of the output crankshaft and displacing fluid in the second output cylinder into the second hydraulic line, and causing the second input piston to move downward as the fluid is displaced from the second hydraulic line into the second input cylinder wherein the downward movement of the second input cylinder rotates the input crankshaft.

It will be noted that by providing output pistons of greater diameter than the input pistons, force is multiplied by the corresponding size ratio. Thus, if the output pistons have four times the surface area as the input pistons, there will be exerted a greater force, wherein the force applied by the output pistons will be four times greater than the force applied to the input pistons, and the output pistons will move through a distance that is one-fourth the distance moved by the input pistons.

More specifically, the present invention is a system of transferring energy comprising an input hydraulic network, an output hydraulic network, an energy source, an energy input apparatus, an energy output apparatus and an external load. The energy source may comprise a battery, for example and without limitation, which is in switchable electrical communication with the energy input apparatus which may comprise, for exemplary purposes only, a motor. A first switch connects the energy source with the energy input apparatus when the first switch is closed. The energy input apparatus is in mechanical communication with an input hydraulic network, wherein the input hydraulic network is in fluid communication with an output hydraulic network via first and second hydraulic lines and wherein the output hydraulic network is in mechanical communication with the energy output apparatus. Utilization of hydraulic lines in lieu of electrical wiring for transfer of energy provides transfer of energy that is not susceptible to electronic interference.

The energy output apparatus may comprise a generator, for example and without limitation, that is in switchable electrical communication with the energy source via a second switch, wherein the energy output apparatus selectively transfers energy to the energy source when the second switch is closed in order to recover any residual energy from momentum of system of transferring energy once energy input apparatus is no longer providing power/energy. The energy output apparatus is also in selective electrical communication with the external load via a third switch, wherein the external load utilizes energy transferred from the energy source via the energy input apparatus, the hydraulic lines and the energy output apparatus.

The input hydraulic network comprises an input housing, wherein the input housing comprises an input housing length and an input housing width, and wherein the input housing length is selectively greater than, or less than, the input housing width to conform to space requirements. The input housing comprises first and second input cylinders with first and second input pistons therewithin, an input crankshaft and first and second input rods. The first and second input cylinders comprise an input cylinder diameter, wherein the first and second input cylinders are in fluid communication with first and second input vent lines, and wherein the input cylinders are in fluid communication with the first and second hydraulic lines, respectively. The first and second input pistons are secured to the input crankshaft via the first and second input rods, respectively, wherein rotation of the input crankshaft alternatively moves the first and second input pistons up and down, along and within the first and second input cylinders via the first and second input rods.

The output hydraulic network comprises an output housing, wherein the output housing comprises an output housing length and an output housing width, and wherein the output housing length is selectively lesser or greater than the output housing width to accommodate space requirements in accordance with the size constraints of the input housing. The output hydraulic network comprises first and second output cylinders, first and second output pistons, an output crankshaft and first and second output rods. The first and second output cylinders comprise an output cylinder diameter, wherein the first and second output cylinders are in fluid communication with first and second output vent lines, and wherein the first and second output cylinders are in fluid communication with the first and second hydraulic lines, respectively. The first and second output pistons are secured to the output crankshaft via the first and second output rods, respectively, wherein rotation of the output crankshaft alternatively moves the first and second output pistons up and down within the first and second output cylinders via the first and second output rods.

Accordingly, in a first example, the output housing length of the output hydraulic network is shorter than the input housing length of the input hydraulic network, thereby permitting configuration of the output hydraulic network to fit a lower profile containment area than the input hydraulic network. The relative dimensions of the input hydraulic network and the output hydraulic network could be reversed, where it is desired that the input hydraulic network have a lower profile than the output hydraulic network (via the input housing length being shorter than the output housing length).

When it is desired that the output hydraulic network have a lower profile (height) than the input network, the input cylinder diameter of the first input cylinder is smaller than the output cylinder diameter of the first output cylinder, wherein the first input cylinder of the input hydraulic network is in fluid communication with the first output cylinder of the output hydraulic network via the first hydraulic line. Similarly, the output cylinder diameter of the second output cylinder is greater than the input cylinder diameter of the second input cylinder, wherein the second output cylinder of the output hydraulic network is in fluid communication with the second input cylinder via the second hydraulic line.

In use, the first switch is closed, wherein the energy source transfers energy to the energy input apparatus. The energy input apparatus converts the electrical energy from the energy source to mechanical energy to initiate rotation of the input crankshaft. As the input crankshaft rotates, the first input rod pushes the first input piston upward along and within the first input cylinder, thereby displacing fluid within the first input cylinder into the first output cylinder via the first hydraulic line, wherein the first output piston consequently slides down the first output cylinder, thereby rotating the output crankshaft. As the crankshaft rotates past top dead center of first input cylinder, first input piston subsequently reverses its direction, pulling fluid from first output cylinder back through first hydraulic line to first input cylinder.

The first input vent permits air to enter/depart below the first input piston and the first output vent permits air to depart/enter from below the first output piston. At the same time, the second input vent permits air to depart/enter below the second input piston and the second output vent permits air to enter/depart from below the second output piston.

Rotation of the input crankshaft eventually pulls the second input piston downward via the second input rod, thereby sucking hydraulic fluid from the second hydraulic line. As hydraulic fluid is removed from the second hydraulic line, the second output piston is pulled upward within its second output cylinder, thereby augmenting rotation of the output crankshaft via the second output rod. Similarly, when rotation of the input crankshaft pushes the second input piston upward, fluid is forced through the second hydraulic line causing the second output piston to move downward within the second output cylinder and consequently causing the output crankshaft to rotate.

As the output piston moves upward on the next portion of the rotational cycle, the second output piston displaces fluid from the second output cylinder into the second hydraulic line, thereby causing the second input piston to slide down and within the second input cylinder providing further rotation of the input crankshaft.

Displacement of fluid between the first and second input cylinders and the first and second output cylinders via the first and second hydraulic lines continues until the first switch is opened, thereby removing energy from the energy source. The energy transferred between the input hydraulic network and the output hydraulic network thus provides energy from the energy source to the energy output device, wherein the energy output apparatus utilizes the transferred energy, and wherein the energy output apparatus selectively transfers energy to the external load or, alternatively, when the energy source is disconnected and no longer providing power/energy to system, the energy output apparatus transfers residual energy from momentum of the system to the energy source when the second switch is closed, thereby partially re-charging the energy source. The first switch and second switch may be controlled via a computer processing unit (CPU).

Accordingly, a feature and advantage of the present invention is its ability to transfer energy through a hydraulic network.

Another feature and advantage of the present invention is its ability to be utilized for stationary or motive energy transfer.

Still another feature and advantage of the present invention is its ability to provide flexibility in providing energy by allowing variation of size to fit physical constraints.

Yet another feature and advantage of the present invention is its ability to be easily sized to different power and/or energy requirements.

Yet still another feature and advantage of the present invention is its ability to utilize a fluid transmission system to overcome EMF effects.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred Embodiments with reference to the accompanying drawing figures, in which like reference numerals denote similar structure and refer to like elements throughout, and in which:

FIG. 1 is a cross-sectional view of a system of transferring energy according to a preferred embodiment of the present invention.

### DETAILED DESCRIPTION OF THE PREFERRED EMBODIMENT OF THE INVENTION

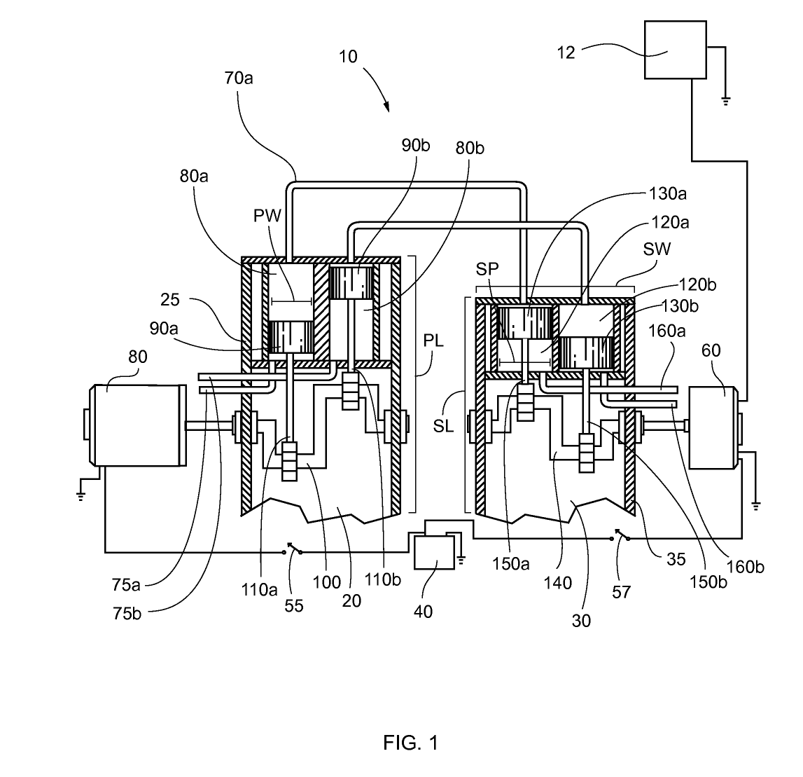

In describing the preferred embodiment of the present invention, as illustrated in FIG. 1, specific terminology is employed for the sake of clarity. The invention, however, is not intended to be limited to the specific terminology so selected, and it is to be understood that each specific element includes all technical equivalents that operate in a similar manner to accomplish similar functions.

As depicted in FIG. 1, the preferred embodiment is system of transferring energy 10 comprising input hydraulic network 20, output hydraulic network 30, energy source 40, energy input apparatus 50, energy output apparatus 60 and external load 12. Energy source 40, such as, for exemplary purposes only, a battery, is in switchable electrical communication with energy input apparatus 50, such as, for exemplary purposes only, a motor, via first switch 55, wherein energy source 40 provides energy to energy input apparatus 50 when first switch 55 is closed. Energy input apparatus 50 is in mechanical communication with input hydraulic network 20, wherein input hydraulic network 20 is in fluid communication with output hydraulic network 30 via first and second hydraulic lines 70a, 70b, and wherein output hydraulic network 30 is in mechanical communication with energy output apparatus 60. Utilization of hydraulic lines 70a, 70b in lieu of electrical wiring for transfer of energy provides transfer of energy that is not susceptible to electronic interference, such as from, for exemplary purposes only, electromagnetic devices in proximity to hydraulic lines 70a, 70b or electromagnetic impulses from sources in the general vicinity of hydraulic lines 70a, 70b.

Energy output apparatus 60, such as, for exemplary purposes only, a generator, is in switchable electrical communication with energy source 40 via second switch 57, wherein energy output apparatus 60 selectively transfers energy to energy source 40 when second switch 57 is closed. Such transfer of energy from energy output apparatus 60 to energy source 40 is utilized when energy input apparatus 50 is idle via opening of first switch 55 in order to recover any residual energy from momentum of system of transferring energy 10 once energy input apparatus 50 is no longer providing power/energy. Energy output apparatus 60 is also in selective electrical communication with external load 12 via third switch 58, wherein external load 12 utilizes energy transferred from energy source 40 via energy input apparatus 50, hydraulic lines 70a, 70b and energy output apparatus 60. It will recognized by those skilled in the art that a mechanical load could replace energy output apparatus 60, with consequent mechanical disengagement in lieu of switch 58.

Input hydraulic network 20 comprises input housing 25, wherein input housing 25 comprises input housing length PL and input housing width PW, and wherein input housing length PL is, in a first example, greater than input housing width PW. Input housing 25 comprises first and second input cylinders 80a, 80b, first and second input pistons 90a, 90b, input crankshaft 100 and first and second input rods 110a, 110b. First and second input cylinders 80a, 80b comprise input cylinder diameter PD, wherein first and second input cylinders 80a, 80b are in communication with first and second input vent lines 75a, 75b, and wherein input cylinders 80a, 80b are in fluid communication with first and second hydraulic lines 70a, 70b, respectively. First and second input pistons 90a, 90b are secured to input crankshaft 100 via first and second input rods 110a, 110b, respectively, wherein rotation of input crankshaft 100 alternatively moves first and second input pistons 90a, 90b up and down along and within first and second input cylinders 80a, 80b via first and second input rods 110a, 110b.

Output hydraulic network 30 comprises output housing 35, wherein output housing 35 comprises output housing length SL and output housing width SW, and wherein output housing length SL is less than output housing width SW. Output hydraulic network 30 comprises first and second output cylinders 120a, 120b, first and second output pistons 130a, 130b, output crankshaft 140 and first and second output rods 150a, 150b. First and second output cylinders 120a, 120b comprise output cylinder diameter SD, wherein first and second output cylinders 120a, 120b are in communication with first and second output vent lines 160a, 160b, and wherein first and second output cylinders 120a, 120b are in fluid communication with first and second hydraulic lines 70a, 70b, respectively. First and second output pistons 130a, 130b are secured to output crankshaft 140 via first and second output rods 150a, 150b, respectively, wherein rotation of output crankshaft 140 alternatively moves first and second output pistons 130a, 130b up and down within first and second output cylinders 120a, 120b via first and second output rods 150a, 150b.

Accordingly, in a first example, output housing length SL of output hydraulic network 30 is shorter than input housing length PL of input hydraulic network 20, thereby permitting configuration of output hydraulic network 30 to fit a lower profile containment area than input hydraulic network 20. It will be recognized by those skilled in the art that, in a second example, the relative dimensions of input hydraulic network 20 and output hydraulic network 30 could be reversed, where it is desired that input hydraulic network 20 have a lower profile than output hydraulic network 30 (via input housing length PL being shorter than output housing length SL).

Returning to the first example, first input cylinder 80a of input hydraulic network 20 is in fluid communication with first output cylinder 120a of output hydraulic network 30 via first hydraulic line 70a, and wherein input cylinder diameter PD of first input cylinder 80a is smaller than output cylinder diameter SD of first output cylinder 120a. Similarly, second output cylinder 120b of output hydraulic network 30 is in fluid communication with second input cylinder 80b via second hydraulic line 70b, wherein output cylinder diameter SD of second output cylinder 120b is greater than input cylinder diameter PD of second input cylinder 80b.

In use, first switch 55 is closed, wherein energy source 40 transfers energy to energy input apparatus 50. Energy input apparatus 50 converts electrical energy from energy source 40 to mechanical energy to initiate rotation of input crankshaft 100 of input hydraulic network 20. As input crankshaft 100 rotates, first input rod 110a pushes first input piston 90a upward along and within first input cylinder 80a, thereby displacing fluid within first input cylinder 80a to first output cylinder 120a via first hydraulic line 70a, wherein first output piston 130a consequently slides down first output cylinder 120a, thereby rotating output crankshaft 140 of output hydraulic network 30. First input vent 75a permits air to enter/depart below first input piston 90a and first output vent 160a permits air to depart/enter from below first output piston 130a. Similarly, second input vent 75b permits air to depart/enter below second input piston 90b and second output vent 160b permits air to enter/depart from below second output piston 130b.

Rotation of input crankshaft 100 pulls second input piston 90b downward via second input rod 110b, thereby sucking hydraulic fluid from second hydraulic line 70b. As hydraulic fluid is removed from second hydraulic line 70b, second output piston 130b is pulled upward within second output cylinder 120b, thereby augmenting rotation of output crankshaft 140 via second output rod 150b. Similarly, when rotation of input crankshaft 100 pushes second input piston 90b upward, fluid is forced through hydraulic line 70b causing second output piston 130b to move downward within second output cylinder 120b and consequently causing output crankshaft 140 to rotate.

As second output piston 130b moves upward on the next portion of the rotational cycle, second output piston 130b displaces fluid from second output cylinder 120b into second hydraulic line 70b, thereby causing second input piston 90b to slide down and within second input cylinder 80b providing further rotation of input crankshaft 100.

Displacement of fluid between first and second input cylinders 80a, 80b and first and second output cylinders 120a, 120b via first and second hydraulic lines 70a, 70b continues until first switch 55 is opened, thereby removing energy from energy source 40. The energy transferred between input hydraulic network 20 and output hydraulic network 30 thus provides energy from energy source 40 to energy output device 60, wherein energy output apparatus 60 utilizes the transferred energy, and wherein energy output apparatus 60 selectively transfers energy to external load 12 or, alternatively, when energy source 40 is disconnected and no longer providing power/energy to system 10, energy output apparatus 60 transfers residual energy from momentum of system 10 to energy source 40 when second switch 57 is closed, thereby partially re-charging energy source 40. It will be recognized by those skilled in the art that first switch 55 and second switch 57 may be controlled via a computer processing unit (CPU).

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A system of transferring energy comprising:
an input hydraulic network, wherein said input hydraulic network comprises an input housing, and wherein said input network comprises an input network length;
an output hydraulic network, wherein said output hydraulic network comprises an output housing, and wherein said output network comprises an output network length, and wherein said output network length is less than said input network length;
an energy source;
an energy input mechanism; and
an energy output mechanism.

2. The system of transferring energy of claim 1, wherein said system further comprises an external load, and wherein said energy output mechanism is in electrical communication with said external load.

3. The system of transferring energy of claim 2, wherein said energy source is in electrical communication with said energy input mechanism via a first switch.

4. The system of transferring energy of claim 3, wherein said energy input mechanism is in mechanical communication with said input hydraulic network.

5. The system of transferring energy of claim 4, wherein said output hydraulic network is in mechanical communication with said energy output mechanism.

6. The system of transferring energy of claim 5, wherein said input hydraulic network is in fluid communication with said output hydraulic network via a first hydraulic line and a second hydraulic line.

7. The system of transferring energy of claim 6, wherein said input hydraulic network comprises a first input cylinder and a second input cylinder, a first input piston and a second input piston, an input crankshaft, and a first input rod and a second input rod, and wherein said first and second input rods connect said first and second input pistons, respectively, to said input crankshaft.

8. The system of storing and transferring energy of claim 7, wherein rotation of said input crankshaft alternately thrusts said first and said second input pistons along and within said first and said second input cylinders, respectively.

9. The system of transferring energy of claim 8, wherein said first and second input cylinders of said input hydraulic network comprise an input cylinder diameter, and wherein said first and second input cylinders are in communication with first and second input vents, respectively, and wherein said first and second input cylinders are in fluid communication with said first and second hydraulic lines, respectively.

10. The system of transferring energy of claim 9, wherein said output hydraulic network comprises a first output cylinder and a second output cylinder, a first output piston and a second output piston, an output crankshaft and a first output rod and a second output rod, and wherein said first and second output rods connect said first and second output pistons, respectively, to said output crankshaft.

11. The system of transferring energy of claim 10, wherein rotation of said output crankshaft alternately thrusts said first and said second output pistons along and within said first and said second output cylinders via said first and said second output rods.

12. The system of transferring energy of claim 11, wherein said first and said second output cylinders of said output hydraulic network comprise an output cylinder diameter, and wherein said first and said second output cylinders are in communication with a first output vent and a second output vent, respectively.

13. The system of transferring energy of claim 12, wherein said input cylinder diameter is less than said output cylinder diameter.

14. A method of transferring energy, said method comprising the steps of:
obtaining a system for transferring energy comprising an input hydraulic network having an input network length, an output hydraulic network having an output network length, an energy source, a first switch, an energy input mechanism, an energy output mechanism, an external load and a second switch, wherein said output network length is less than said input network length, and wherein said input hydraulic network comprises a first input cylinder, a second input cylinder, a first input piston, a second input piston, a first input rod, a second input rod and a input crankshaft, and wherein said output hydraulic network comprises a first output cylinder, a second output cylinder, a first output piston, a second output piston, a first output rod and a second output rod and an output crankshaft, and wherein said first and said second input cylinders comprise an input cylinder diameter, and wherein said first and said second output cylinders comprise a output cylinder diameter, and wherein said input cylinder diameter is less than said output cylinder diameter;
closing said first switch to transfer energy from said energy source to said energy input mechanism;
transferring said energy from said energy input mechanism to said input hydraulic network;
displacing fluid between said input hydraulic network and said output hydraulic network via first and second hydraulic lines;
transferring said fluid from said first and second hydraulic lines to said output hydraulic network; and
transferring said energy from said output hydraulic network to said energy output mechanism.

15. The method of transferring energy of claim 14, wherein said step of displacing fluid between said input hydraulic network and said output hydraulic network via said first and said second hydraulic lines further comprises the steps of:
rotating said input crankshaft, thereby pushing said first input cylinder upward and displacing said fluid in said first input cylinder into said first hydraulic line;
displacing said fluid in said first hydraulic line into said first output cylinder;
causing said first output piston to move downward as said fluid is displaced from said first hydraulic line into said first output cylinder, wherein said downward movement of said first output piston rotates said output crankshaft;
pushing said second output piston upward via rotation of said output crankshaft and displacing said fluid in said second output cylinder into said second hydraulic line; and
causing said second input piston to move downward as said fluid is displaced from said second hydraulic line into said second input cylinder wherein said downward movement of said second input cylinder rotations said input crankshaft.

16. The method of transferring energy of claim 15, said method further comprising the step of:
recovering unused energy from momentum of said output energy mechanism.

17. The method of transferring energy of claim 16, said method further comprising the step of:
utilizing said output energy mechanism to energize said external load.

18. An energy transferring system comprising:
an input hydraulic network comprising an input network length, input cylinders, input pistons, input rods and an input crankshaft, wherein said input cylinders comprise an input cylinder diameter;
an output hydraulic network comprising an output network length, output cylinders, output pistons, output rods and an output crankshaft, wherein said output cylinders comprise an output cylinder diameter, and wherein said output network length is shorter than said input network length;
an energy source; and
an energy output mechanism.

19. The energy transferring and storing system of claim 18, wherein said energy source is in electrical communication with an energy input mechanism, and wherein said energy input mechanism is in mechanical communication with said input hydraulic network, and wherein said input hydraulic network is in fluid communication with said output hydraulic network via first and second hydraulic lines, and wherein said output hydraulic network is in mechanical communication with said energy output mechanism.

20. The energy transferring system of claim 19, wherein said energy input mechanism is in electrical communication with said energy source via a switch.
